(19) United States
(12) Patent Application Publication
(10) Pub. No.: US 2001/0050716 A1
(43) Pub. Date: Dec. 13, 2001

(54) LIQUID CRYSTAL DISPLAY APPARATUS

(76) Inventors: KAZUO HASHIMOTO, KANAGAWA (JP); YUTAKA NAKAGAWA, KANAGAWA (JP); TSUTOMU NIIMURA, KANAGAWA (JP); MAKOTO ONGA, KANAGAWA (JP)

Correspondence Address: FROMMER LAWRENCE & HAUG, 745 FIFTH AVENUE- 10TH FL., NEW YORK, NY, 10151, US

(21) Appl. No.: 08/991,354

(22) Filed: Dec. 16, 1997

(30) Foreign Application Priority Data
Dec. 27, 1996 (JP) 8-350560

(51) Int. Cl. H04N 5/222

(52) U.S. Cl. 348/333.01; 348/333.06

(57) ABSTRACT

To preferably display an image on a liquid crystal display panel at any time irrespective of a circumferential environment, a liquid crystal display panel (LCD) (1) is constructed by a front side polarizing means (11), a front side transparent plate body (12), a liquid crystal display section (13) of a transmitting type, a rear side transparent plate body (14), and a rear side polarizing means (15). A back light means constructed by a fluorescent lamp (2), a reflector (3) and a light guiding plate (4) having a triangular shape is provided on a rear side of the liquid crystal display panel (1). Further, a light diffusing plate (5) such as a prism plate, a diffusing film, etc. is provided between the liquid crystal display panel (1) and a light emitting face of the light guiding plate (4) of the back light means. A circuit substrate (6) for driving the liquid crystal display panel (1) is provided on a rear side of the light guiding plate (4) of the back light means. All these members are accommodated in a box body (7) so that a liquid crystal display apparatus (200) is formed. In this display apparatus, for example, a semitransmitting reflecting means (10) is provided on a rear side of the rear side polarizing means (15) in the liquid crystal display panel (1).

### BACKGROUND OF THE INVENTION

The present invention relates to a liquid crystal display apparatus suitably mounted to a video camera of a single-unit video camera-recorder (VCR) type.

For example, in the video camera of a single-unit video camera-recorder type, a video signal during a photographing operation and a video signal regenerated from the video camera-recorder are displayed by mounting the liquid crystal display apparatus to the video camera.

FIG. 1 shows an external appearance of such an example of camera the single-unit video camera-recorder type. In FIG. 1, for example, a liquid crystal display apparatus 200 is arranged on a side face of a video camera body 100 of the single-unit video camera-recorder type such that this liquid crystal display apparatus 200 can be freely opened and closed and rotated. This liquid crystal display apparatus 200 displays thereon a video signal during a photographing operation using the video camera body 100 of the single-unit video camera-recorder type and a video signal reproduced from the video camera-recorder.

In such a liquid crystal display apparatus 200, a so-called back light means is normally provided to easily see displayed contents thereon when the video camera is used during the night and indoors, etc. FIG. 2 shows a cross section of the above liquid crystal display apparatus 200. In FIG. 2, a back light means constructed by a fluorescent lamp 42, a reflector 43 and a light guiding plate 44 having a triangular shape is provided on the rear side of a liquid crystal display panel (LCD) 41.

Further, a light diffusing plate 45 such as a prism plate, a diffusing film, etc. is provided between a light emitting face of the light guiding plate 44 of this back light means and the liquid crystal panel 41. A circuit substrate 46 for operating the liquid crystal display panel 41 is provided on a rear side of the light guiding plate 44 of the back light means. All these members are accommodated in a box body 47 so that the liquid crystal display apparatus 200 is formed.

In this liquid crystal display apparatus, when the fluorescent lamp 42 of the above back light means is turned on, a light ray (arrow a in FIG. 2) from this fluorescent lamp 42 is directly incident to an end face of the light guiding plate 44. This light ray is also reflected on the reflector 43 and is incident to the end face of the light guiding plate 44. The light ray incident to the end face of this light guiding plate 44 is emitted from the entire light emitting face of the light guiding plate 44 and is diffused to a uniform light ray by the light diffusing plate 45. This light ray thus diffused is then irradiated onto the rear side of the liquid crystal display panel 41.

The video signal during the photographing operation using the above video camera body 100 and the video signal reproduced from the video camera-recorder are also supplied to the liquid crystal display panel 41 through the circuit substrate 46 so that images according to these video signals are displayed on one liquid crystal display panel 41. These images are clearly displayed on the liquid crystal display panel 41 by irradiating the light beam of the back light means to this liquid crystal display panel 41 from its rear side even in a dark circumferential environment such as nighttime, the interior of a house, etc.

However, when such a liquid crystal display apparatus 200 is used under the outdoor sunlight, it is observed that the display on the liquid crystal display panel 41 is difficult to can be easily seen. Namely, in the above liquid crystal display apparatus, the light ray from the back light means irradiated on the rear side of the liquid crystal display panel 41 has about 1000 nit. Light transmittance of the liquid crystal display panel 41 is about 7% so that a displayed light amount is about 70 nit.

In contrast to this, a sunlight amount becomes equal to or greater than several 10 to 100 times the above displayed light amount. Therefore, when the above liquid crystal display apparatus 200 is used under the sunlight, the display on the liquid crystal display panel 41 can not be almost seen by the difference in light amount between the liquid crystal display panel and its circumference. A hood, etc. are arranged around the liquid crystal display apparatus 200 to take measures to cope with this situation. However, these measures are complicated and not so effective.

The above situation can be improved to a certain extent by increasing the light amount of the back light means. However, problems exist in that power consumption is greatly increased and a shape of the back light means itself is large-sized, etc. to increase the light amount of the back light means. Therefore, for example, it is difficult to really mount the liquid crystal display apparatus to the video camera of a single-unit video camera-recorder type, etc. since a setting construction, etc. are limited.

In contrast to this, a so-called liquid crystal display apparatus of a reflecting type is proposed. In the liquid crystal display apparatus of this reflecting type, for example, a reflecting plate 52 is provided on the rear side of a liquid crystal display panel 51 as shown in FIG. 3 such that the reflecting plate 52 comes in close contact with this rear side of the liquid crystal panel 51. A circuit substrate 53 for operating the liquid crystal display panel 51 is provided on a rear face side of this reflecting plate 52. All these members are accommodated in a box body 54 so that the liquid crystal display apparatus 200 is formed.

For example, when this display apparatus is used under the outdoor sunlight, etc. and external light (arrow b in FIG. 3) such as the sunlight, etc. is irradiated onto a display face of the liquid crystal display apparatus 200, this light beam is penetrated through the liquid crystal display panel 51 and is irradiated onto the reflecting plate 52 on the rear side. The light ray reflected on this reflecting plate 52 is irradiated onto the rear side of the liquid crystal display panel 51.

On the other hand, the video signal during the photographing operation using the above video camera body 100 or the video signal reproduced from the video camera-recorder is supplied to the liquid crystal display panel 51 through the circuit substrate 53 so that images according to these video signals are displayed on the liquid crystal panel 51. These images are clearly displayed on the liquid crystal display panel 51 by irradiating the light ray reflected on the reflecting plate 52 to this liquid crystal display panel 51 from its rear side.

Accordingly, the images can be clearly displayed on the liquid crystal display panel 51 by reflected light of the external light such as the sunlight, etc. even when this display apparatus is used in a bright environment such as an environment under the outdoor sunlight, etc. However, in this display apparatus, no display can be easily seen in a dark circumferential environment such as nighttime and the interior of a house, etc. Therefore, when the display apparatus is used in such an environment, it is necessary to separately arrange lighting facilities, etc. so as to obtain the external light.

### SUMMARY OF THE INVENTION

In view of such aspects, it is an object of the present invention to provide a liquid crystal display apparatus mounted to a video camera of a single-unit video camera-recorder type which can solve the problem that no display in the liquid crystal display apparatus of a transmitting type can be easily seen in a bright circumferential environment such as an environment under the outdoor sunlight, etc., and the problem that no display in the liquid crystal display apparatus of a reflecting type can be easily seen in a dark circumferential environment such as nighttime and the interior of a house, etc.

Therefore, in the present invention, a semitransmitting reflecting means is provided between a back light means located on the rear side of a display panel and a liquid crystal display section of the display panel. Accordingly to this arrangement, a light ray from the back light means is penetrated through the semitransmitting reflecting means and is irradiated onto the display panel. Further, external light is reflected by the semitransmitting reflecting means and is irradiated to the display panel.

Namely, in the present invention, there is provided a display panel which has a front side polarizing means, a front side transparent plate body, the liquid crystal display section of a transmitting type, a rear side transparent plate body and a rear side polarizing means. The back light means is located on a rear side of this display panel. The semitransmitting reflecting means is located between the back light means and the liquid crystal display section of a transmitting type.

### BRIEF DESCRIPTION OF THE DRAWINGS

FIG. 1 is a perspective view showing the external appearance of a video camera of a single-unit video camera-recorder type as one example in which a liquid crystal display apparatus is mounted to the video camera;

FIG. 2 is a cross-sectional view showing the construction of a conventional liquid crystal display apparatus of a transmitting type;

FIG. 3 is a cross-sectional view showing the construction of a conventional liquid crystal display apparatus of a reflecting type;

FIG. 4 is a cross-sectional view showing an example of a liquid crystal display apparatus to which the present invention is applied; and

FIGS. 5A to 5C are views for explaining the liquid crystal display apparatus of the present invention.

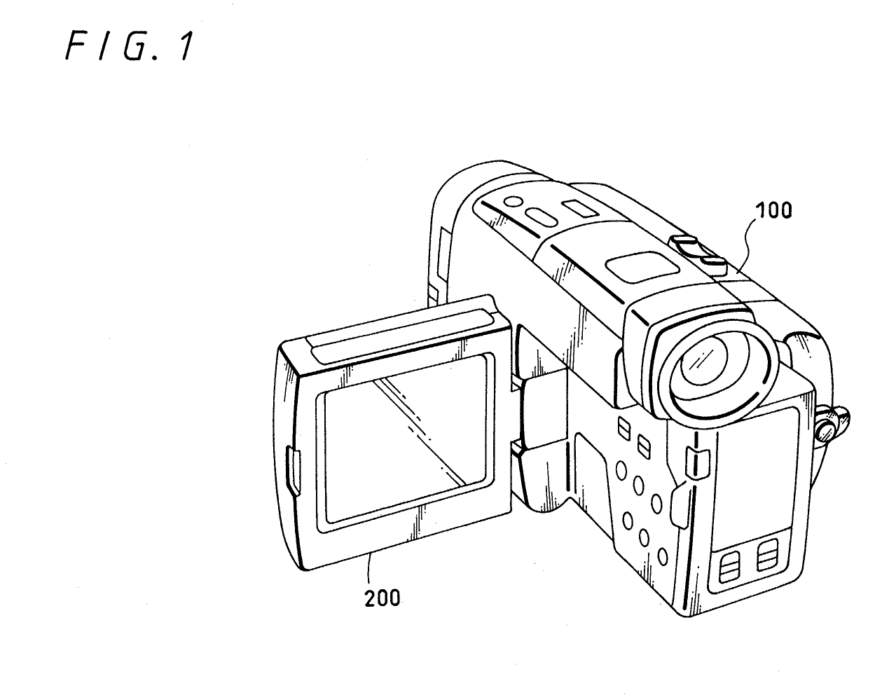

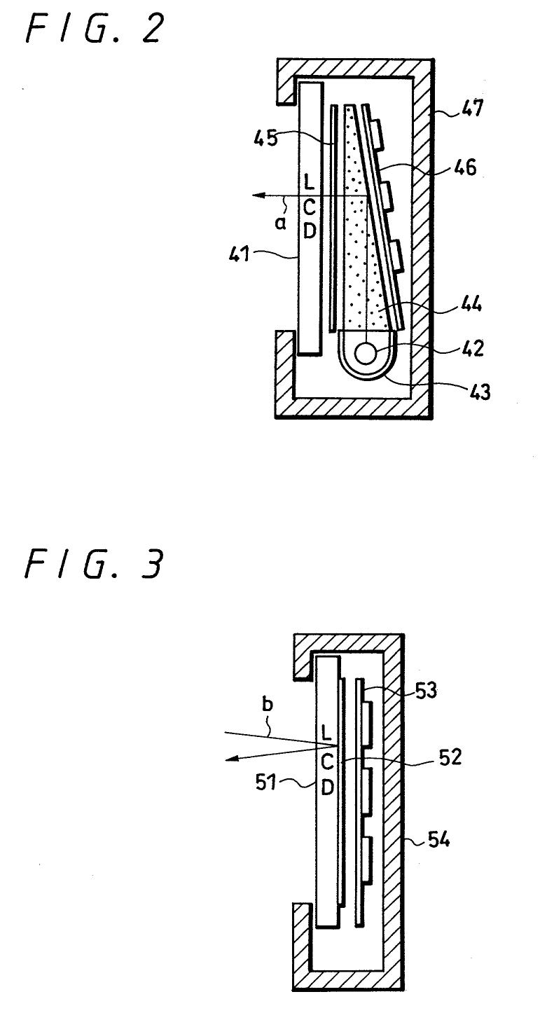

### DETAILED DESCRIPTION OF THE PREFERRED EMBODIMENTS

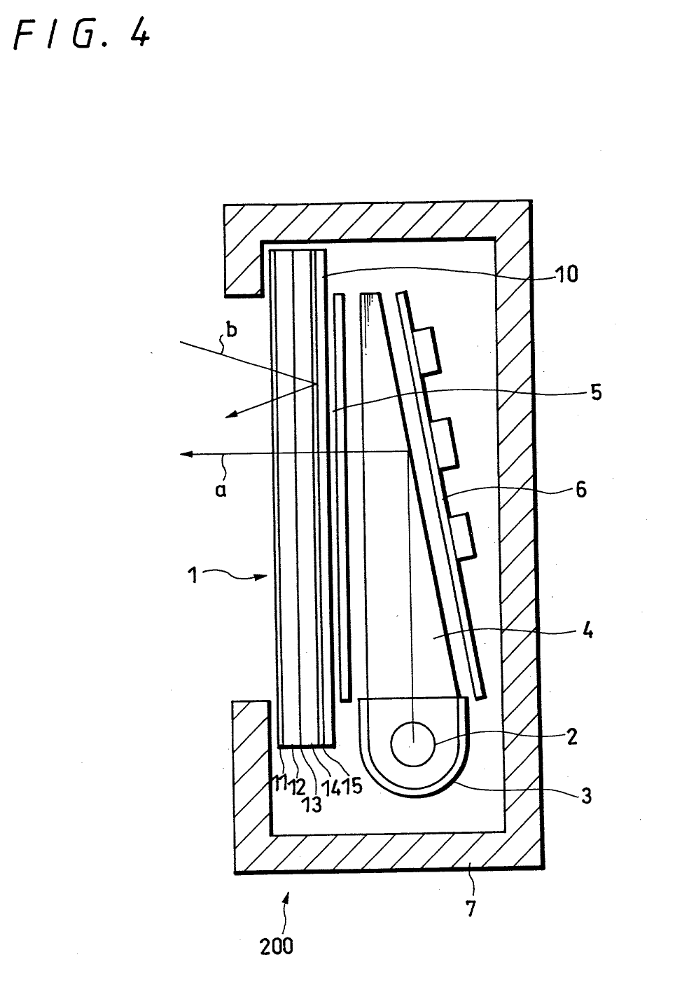

The present invention will next be described with reference to the drawings. FIG. 4 is a cross-sectional view showing the construction of an example of liquid crystal display apparatus to which the present invention is applied.

In this FIG. 4, a liquid crystal display panel (LCD) 1 is constructed by a front side polarizing means 11, a front side transparent plate body 12, a liquid crystal display section 13 of a transmitting type, a rear side transparent plate body 14 and a rear side polarizing means 15. A back light means constructed by a fluorescent lamp 2, a reflector 3 and a light guiding plate 4 having a triangular shape is provided on a rear side of the liquid crystal display panel 1.

Further, a light diffusing plate 5 such as a prism plate, a diffusing film, etc. is located between the liquid crystal display panel 1 and a light emitting face of the light guiding plate 4 of the back light means. A circuit substrate 6 for driving the liquid crystal display panel 1 is arranged on a rear side of the light guiding plate 4 of the back light means. These members all housed in a box body 7 so that a liquid crystal display apparatus 200 is formed.

In this display apparatus, for example, a semitransmitting reflecting means 10 is provided on a rear side of the rear side polarizing means 15 in the liquid crystal display panel 1. For example, this reflecting means 10 is constructed by a half mirror or a magic mirror in which aluminum, etc. are evaporated to a thin transparent film base. For example, the film base constituting this reflecting means 10 is stuck to the rear side of the rear side polarizing means 15.

Namely, in this display apparatus, when the fluorescent lamp 2 of the back light means is turned on, a light beam (arrow a) from this fluorescent lamp 2 is directly incident to an end face of the light guiding plate 4. The light beam from this fluorescent lamp 2 is also reflected on the reflector 3 and is incident to the end face of the light guiding plate 4. The light beam incident to the end face of this light guiding plate 4 is emitted from an entire light emitting face of the light guiding plate 4 and is changed to a uniform light ray by the light diffusing plate 5. Thereafter, this uniform light ray is penetrated through the semitransmitting reflecting means 10 and is irradiated onto the rear side of the liquid crystal display panel 1.

For example, when this display apparatus is used under the outdoor sunlight, etc. and external light (arrow b in FIG. 4) such as the sunlight, etc. is irradiated onto a display surface of the liquid crystal display apparatus 200, this external light ray is transmitted through the liquid crystal display panel 1 and is irradiated onto the reflecting means 10 on the rear side there of. The light ray reflected on the reflecting means 10 is then irradiated onto the rear side of the liquid crystal display panel 1.

On the other hand, for example, a video signal during a photographing operation using a video camera body and a video signal reproduced from a video camera-recorder are also supplied to the liquid crystal display panel 1 through the circuit substrate 6 so that images according to these video signals are displayed there on. The light ray from the back light means, or the light ray reflected by the reflecting means 10 is irradiated onto this liquid crystal display panel 1 from its rear side so that the images are displayed on the liquid crystal display panel 1.

In this display apparatus, the semitransmitting reflecting means is located between the back light means located on the rear side of the liquid crystal display panel 1 and the liquid crystal display section of the liquid crystal display panel, whereby the light ray from the back light means is penetrated through the semitransmitting reflecting means and is irradiated onto the liquid crystal display panel, and also the external light is reflected by the semitransmitting reflecting means and is irradiated onto the liquid crystal display panel. Therefore, the images can be preferably displayed on the liquid crystal display panel at any time.

The conventional liquid crystal display apparatus of a transmitting type has the problem that no display difficult to be seen in a bright circumferential environment such as an environment under the outdoor sunlight, etc, while the conventional liquid crystal display apparatus of a reflecting type has the problem that a display is difficult to be seen in a dark circumferential environment such as nighttime and the interior of a house, etc. However, according to the present invention, an image displayed on the liquid crystal display panel can be easily seen at any time even in a bright circumferential environment and a dark circumferential environment.

The liquid crystal display apparatus of the present invention is suitably adopted as a display apparatus mounted to, for example, the video camera of a single-unit video camera-recorder type which is frequently used without particularly separately using this video camera outdoors and indoors.

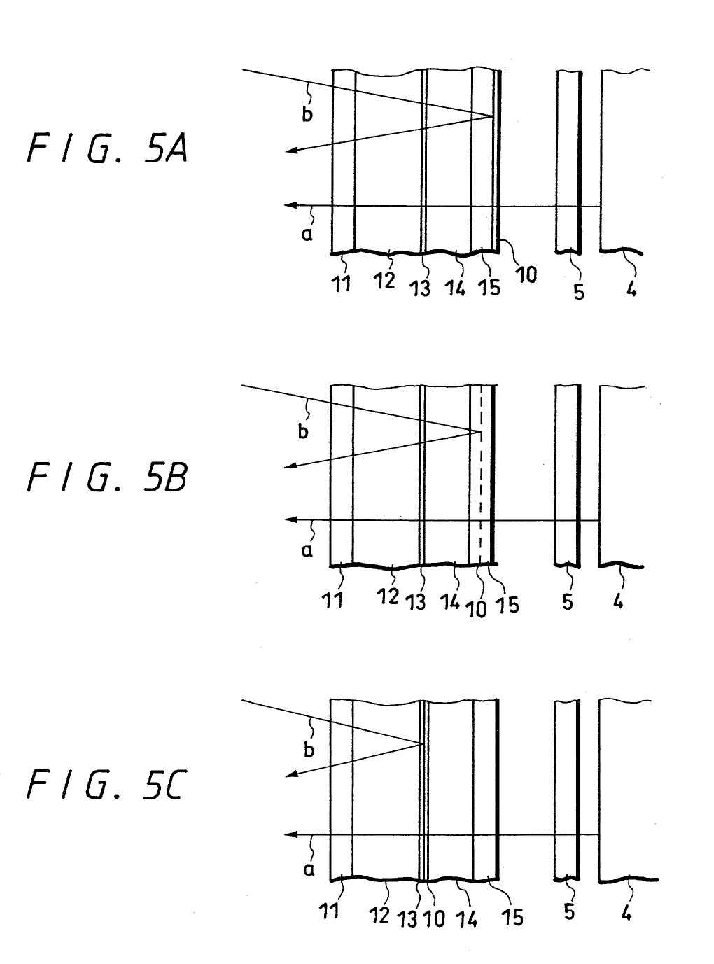

In the above-mentioned embodiment, for example, the semitransmitting reflecting means 10 is provided on the rear side of the rear side polarizing means 15 of the liquid crystal display panel 1. However, the semitransmitting reflecting means 10 may be arranged at any place between the above back light means (the light diffusing plate 5) and the liquid crystal display section 13. FIGS. 5A to 5C show locating positions of the semitransmitting reflecting means 10—respectively. FIG. 5A shows a case in which the semitransmitting reflecting means 10 is located on the rear side of the above rear side polarizing means 15.

In contrast to this, FIG. 5B shows a case in which the semitransmitting reflecting means 10 is formed together with the rear side polarizing means 15 provided in the liquid crystal display panel 1. For example, the polarizing means is formed by laminating a plurality of films with one another. Therefore, a film base constituting the above-mentioned semitransmitting reflecting means 10 can be laminated together with these laminated films.

Further, FIG. 5C shows a case in which the semitransmitting reflecting means 10 is located on the rear side of the liquid crystal display section 13 of the liquid crystal display panel 1. Accordingly, in this case, it is necessary to arrange a process for forming the semitransmitting reflecting means 10 at a manufacturing stage of the liquid crystal display panel 1. However, in this example, it is possible to solve problems such as a color shift, etc. caused by a clearance formed between the liquid crystal display section 13 and the semitransmitting reflecting means 10.

Thus, in accordance with the above liquid crystal display apparatus, there is provided the display panel which has the front side polarizing means, the front side transparent plate body, the liquid crystal display section of a transmitting type, the rear side transparent plate body and the rear side polarizing means. The back light means is arranged on a rear side of this display panel, and also the semitransmitting reflecting means is arranged between the back light means and the liquid crystal display section of a transmitting type. Accordingly, an image can be preferably displayed on the liquid crystal display panel at any time.

In the above-mentioned display apparatus, the semitransmitting reflecting means 10 is not limited to a case in which this semitransmitting reflecting means 10 is formed by a half mirror or a magic mirror constructed by evaporating aluminum, etc. onto the above-mentioned thin transparent film base. For example, the semitransmitting reflecting means 10 can be formed by an arbitrary method using another metal, acrylic resin, etc.

In accordance with the present invention, the semitransmitting reflecting means is located between the back light means arranged on the rear side of the liquid crystal display panel and the liquid crystal display section of the liquid crystal display panel, so that the light ray from the back light means is penetrated through the semitransmitting reflecting means and is irradiated onto the liquid crystal display panel. Further, external light is reflected by the semitransmitting reflecting means and is irradiated onto the liquid crystal display panel. Therefore, an image can be preferably displayed on the liquid crystal display panel at any time.

The conventional liquid crystal display apparatus of a transmitting type has the problem that a display is difficult to be seen in a bright circumferential environment such as an environment under the outdoor sunlight, etc, while the conventional liquid crystal display apparatus of a reflecting type has the problem that a display is difficult to be seen in a dark circumferential environment such as nighttime and the interior of a house, etc. However, according to the present invention, an image displayed on the liquid crystal display panel can be easily seen at any time even in a bright circumferential environment and a dark circumferential environment.

Having described preferred embodiments of the present invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A liquid crystal display apparatus comprising:
a display panel having a liquid crystal display section of a transmitting type;
a back light means provided on a rear side of said display panel; and
semitransmitting reflecting means arranged between said back light means and the liquid crystal display section of a transmitting type.

2. The liquid crystal display apparatus as claimed in claim 1, wherein said display panel further comprises a front side polarizing means, a front side transparent plate body, a rear side transparent plate body, and a rear side polarizing means.

3. The liquid crystal display apparatus as claimed in claim 1, wherein said display panel is mounted to a video camera of a single-unit VTR type.

4. The liquid crystal display apparatus as claimed in claim 1, wherein said semitransmitting reflecting means is located on a rear side of said display panel.

5. The liquid crystal display apparatus as claimed in claim 1, wherein said semitransmitting reflecting means is formed together with said rear side polarizing means provided in said display panel.

6. The liquid crystal display apparatus as claimed in claim 1, wherein said semitransmitting reflecting means is formed on a rear side of said liquid crystal display section of a transmitting type.

7. A camera comprising: a liquid crystal display apparatus formed of a display panel having a liquid crystal display section of a transmitting type, a back light means provided on a rear side of said display panel, and a semitransmitting reflecting means provided between said back light means and said liquid crystal display section of a transmitting type; and an image pickup means for optically picking-up an image.

8. The camera according to claim 7, further comprising a video signal recording means and/or video signal reproducing means.
